(19) United States
(12) Patent Application Publication
(10) Pub. No.: US 2016/0273445 A1
(43) Pub. Date: Sep. 22, 2016

(54) CONTROLLING FLOW OF EXHAUST GAS INTO TURBOCHARGER OF ENGINE

(71) Applicant: Caterpillar Inc., Peoria, IL (US)

(72) Inventor: David A. Pierpont, Dunlap, IL (US)

(73) Assignee: Caterpillar Inc., Peoria, IL (US)

(21) Appl. No.: 15/168,508

(22) Filed: May 31, 2016

(51) Int. Cl. F02B 37/18

(52) U.S. Cl. CPC F02B 37/186

(57) ABSTRACT

A system for controlling flow of exhaust gas into a turbocharger of an engine is provided. The system includes an exhaust manifold having a first outlet port and a second outlet port. A valve element is pivotally coupled between the first and the second outlet ports. The system includes a control module that determines a value of load condition of the engine. The control module actuates the valve element from a first position to a second position when the value of the load condition is less than a threshold. In the first position, the valve element directs exhaust gas received from a first set of cylinders and a second set of cylinders to the first outlet port and the second outlet port, respectively. In the second position, the valve element allows the exhaust gas to enter one of the first outlet port and the second outlet port.

### TECHNICAL FIELD

The present disclosure relates to a turbocharged engine and more particularly relates to a system for controlling flow of exhaust gas to a turbocharger.

### BACKGROUND

Typically, a turbocharger is disposed in fluid communication with an exhaust manifold of an engine to extract power from exhaust gas. With the development of engine technology, dual-inlet turbochargers are employed to extract additional power from the exhaust gas and address various load conditions of the engine. Exhaust manifold of the engine is provided with two outlets to communicate with two inlet passages defined within a housing of the dual-inlet turbocharger.

Turbochargers, including the dual-inlet turbocharger, are designed to achieve desired engine operation efficiency under the various load conditions of the engine, such as a low load condition and a high load condition. However, the turbochargers are associated with a predetermined response time to attain the desired engine operation efficiency. For example, when the engine is operating at low load conditions, the turbocharger may take higher response time to address a sudden increase in load demand. Further, when the engine is operating at high load conditions, a speed of the turbine may exceed a threshold speed, thereby causing the components of the turbocharger to wear out quickly. Therefore, there exists a need to minimize the response time whilst maintaining the turbocharger in an operating condition.

U.S. Pat. No. 8,166,754, hereinafter referred to as the '754 patent, describes an exhaust manifold for an internal combustion engine. The exhaust manifold includes a central part with two exhaust gas flow ducts extending from the central part in opposite directions for collecting exhaust gas from first and second cylinder groups of the engine. The central part includes a first control valve for controlling the exhaust gas flow from the first and the second cylinder groups to first and second turbine inlet flow passages, a second control valve for controlling the exhaust gas pressure, and a third control valve for controlling the exhaust gas recirculation rate. However, the exhaust manifold of the '754 patent has a complex design which may increase an overall cost of the internal combustion engine.

### SUMMARY OF THE DISCLOSURE

In one aspect of the present disclosure, a system for controlling flow of exhaust gas into a turbocharger of an engine is provided. The system includes an exhaust manifold having a plurality of inlet ports in fluid communication with a plurality of cylinders of the engine to receive exhaust gas therefrom. The exhaust manifold includes a pair of outlet ports in fluid communication with the turbocharger of the engine. The pair of outlet ports includes a first outlet port and a second outlet port to communicate with a first inlet port and a second inlet port, respectively, of the turbocharger. The system also includes a valve element pivotally coupled within the exhaust manifold between the first outlet port and the second outlet port. The valve element is movable between a first position and a second position. The system also includes an actuating unit coupled to the valve element and adapted to move the valve element between the first position and the second position. The system also includes a control module in electronic communication with the actuating unit. The control module is configured to receive an input indicative of an operating parameter of the engine. The control module is further configured to determine a value of load condition of the engine based on the operating parameter. The control module is further configured to compare the value of the load condition of the engine with a threshold. The control module is further configured to actuate the valve element from the first position to the second position through the actuating unit when the value of the load condition is less than the threshold. Further, in the first position, the valve element directs the exhaust gas received from a first set of the plurality of cylinders to the first outlet port and the exhaust gas received from a second set of the plurality of cylinders to the second outlet port. In the second position, the valve element allows the exhaust gas received from the plurality of cylinders to enter one of the first outlet port and the second outlet port.

Other features and aspects of this disclosure will be apparent from the following description and the accompanying drawings.

### BRIEF DESCRIPTION OF THE DRAWINGS

FIG. 1 is a schematic representation of an engine having a system for controlling flow of exhaust gas into a turbocharger, according to an embodiment of the present disclosure;

FIG. 2 is a block diagram of the system of FIG. 1;

FIG. 3 is a schematic representation of a portion of an exhaust manifold having a valve element disposed therein at a first position; and

FIG. 4 is a schematic representation of the portion of the exhaust manifold having the valve element disposed at a second position.

### DETAILED DESCRIPTION

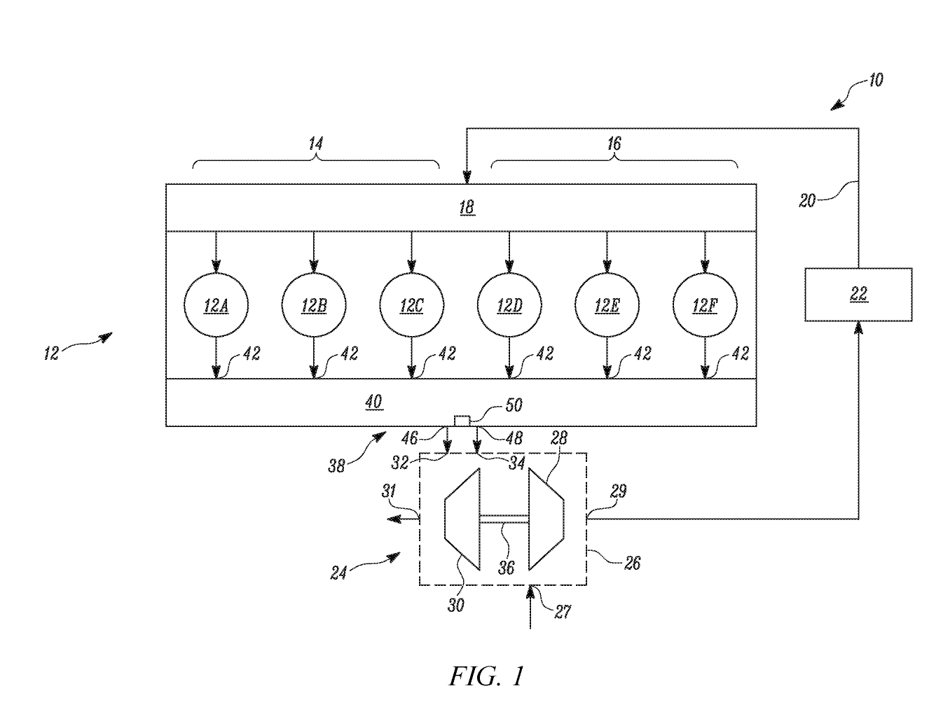

FIG. 1 shows a schematic representation of an exemplary engine 10. The engine 10 may run on fuels, such as diesel, gasoline, gaseous fuels, or a combination thereof. The engine 10 may provide power to a machine, such as an excavating machine, a passenger vehicle, an electric generator, a mining truck, a marine vessel, or an agricultural machine. The engine 10 includes a number of cylinders 12A, 12B, 12C, 12D, 12D, 12E, 12F, hereinafter collectively referred to as the cylinders 12. Although the engine 10 having six cylinders 12 is shown in FIG. 1, it is understood that the present disclosure may be implemented in an engine having even number of cylinders arranged in an in-line type configuration, a V-type configuration, a rotary type configuration, or any other types of configuration known in the art. The number of cylinders 12 includes a first set of cylinders 14 and a second set of cylinders 16. Each of the first set of cylinders 14 and the second set of cylinders 16 includes half number of the cylinders 12. As shown in FIG. 1 the first set of cylinders 14 includes three cylinders 12A, 12B, 12C and the second set of cylinders 16 includes three cylinders 12D, 12E, and 12F. The engine 10 may include one or more fuel injectors (not shown) for supplying fuel to the respective cylinders 12. The engine 10 further includes an intake manifold 18 in fluid communication with an intake line 20 of the engine 10. Each of the cylinders 12 receives air for the combustion of fuel therein from the intake manifold 18.

The engine 10 also includes an exhaust manifold 40 in communication with the cylinders 12. The exhaust manifold 40 receives exhaust gas generated due to combustion of fuel in the cylinders 12. The exhaust manifold 40 includes a number of inlet ports 42. The number of inlet ports 42 is in fluid communication with the cylinders 12 of the engine 10 to receive exhaust gas. The exhaust manifold 40 also includes a pair of outlet ports 44. The pair of outlet ports 44 includes a first outlet port 46 and a second outlet port 48.

The engine 10 further includes a turbocharger 24 in fluid communication with the exhaust manifold 40. The turbocharger 24 is provided for increasing a flow of intake air into the cylinders 12 of the engine 10. The turbocharger 24 includes a housing 26, a compressor 28 enclosed within the housing 26, and a turbine 30 drivably coupled to the compressor 28. The housing 26 includes a first inlet port 32 and a second inlet port 34. The first inlet port 32 and the second inlet port 34 communicate with the first outlet port 46 and the second outlet port 48, respectively, of the exhaust manifold 40. Specifically, the exhaust gas produced within the cylinders 12 travels through the exhaust manifold 40 to enter the housing 26 of the turbocharger 24 through the first outlet port 46 and the second outlet port 48. Further, the housing 26 defines a turbocharger inlet port 27 for receiving ambient air, and a first turbocharger outlet port 29 for supplying pressurized air to the intake line 20 of the engine 10.

The compressor 28 is in fluid communication with the intake line 20 of the engine 10, via the first turbocharger outlet port 29. The compressor 28 receives the ambient air through the turbocharger inlet port 27. The compressor 28 increases a pressure of the air before being supplied to the intake line 20 depending upon a rotational speed of the compressor 28. The pressurized air thus generated exits the housing 26 of the turbocharger 24 to enter the intake line 20, via the first turbocharger outlet port 29. The pressurized air further travels through an air cooler 22. The air cooler 22 cools the pressurized air before being supplied to the cylinders 12 of the engine 10.

Further, the turbine 30 is connected to the compressor 28 by a shaft 36. The turbine 30 is driven by the exhaust gas generated within the cylinders 12 during the combustion process. The turbine 30 is arranged within the housing to receive the exhaust gas from the cylinders 12, via the first inlet port 32 and the second inlet port 34. The exhaust gas received through the first inlet port 32 and the second inlet port 34 expands against blades of the turbine 30 and drives the turbine 30, thereby resulting in corresponding rotation of the compressor 28. The exhaust gas further exits the housing 26 of the turbocharger 24, via a second turbocharger outlet port 31, to enter an after-treatment system (not shown) of the engine 10.

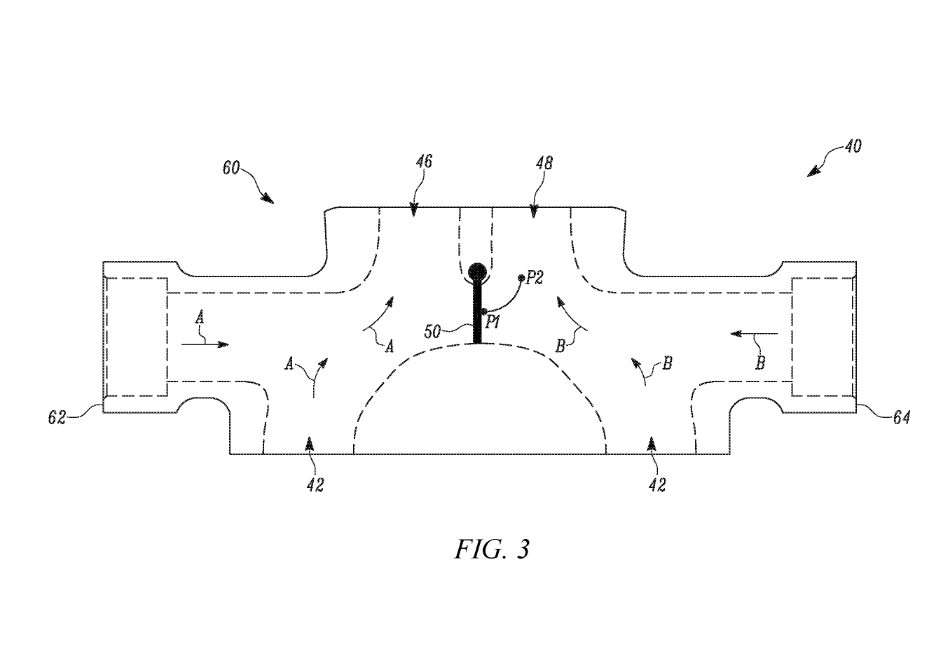

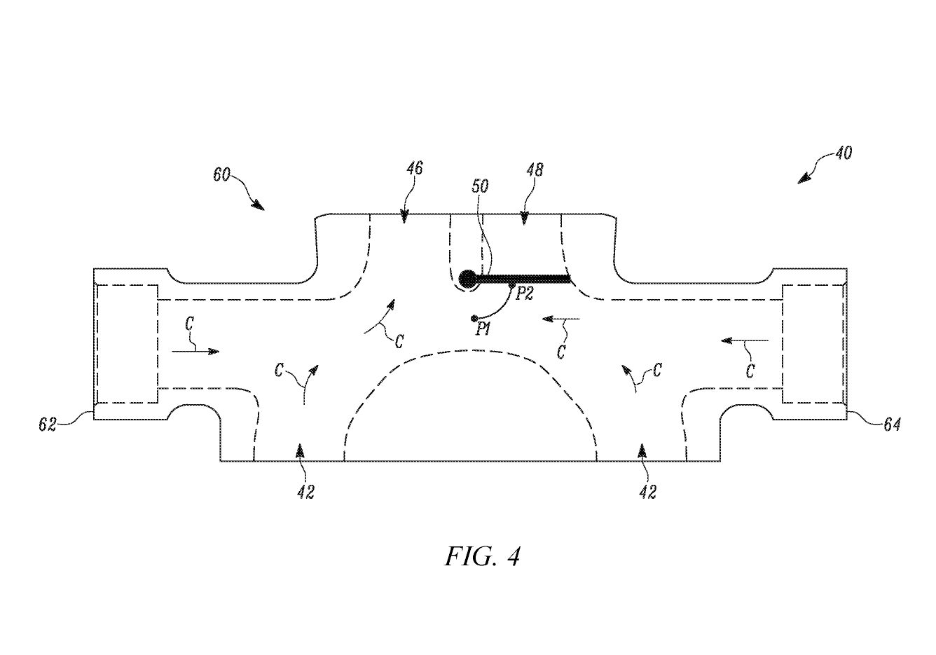

The present disclosure relates to a system 38 that controls flow of exhaust gas into the turbocharger 24. The system 38 includes a valve element 50 disposed within the exhaust manifold 40. The valve element 50 is pivotally connected to the exhaust manifold 40 between the first outlet port 46 and the second outlet port 48. The valve element 50 is movable between a first position “P1” (shown in FIG. 3) and a second position “P2” (shown in FIG. 4) to control the flow of exhaust gas to the turbocharger 24. In particular, the valve element 50 selectively restricts flow of the exhaust gas received from the cylinders 12 to the second outlet port 48, thereby restricting flow of the exhaust gas to the second inlet port 34 of the turbocharger 24 based on an operating condition of the engine 10.

In an example, the valve element 50 may be a planar member that is pivotally connected to the exhaust manifold 40. The valve element 50 may be pivoted to a wall of the exhaust manifold 40 between the first outlet port 46 and the second outlet 48 port by a pivot shaft. The pivot shaft allows a rotational movement of the valve element 50 from the first position “P1” to the second position “P2” to close the second outlet port 48. Further, the valve element 50 may have a size and a shape substantially similar to a size and a shape of the second outlet port 48 and a passage of the exhaust manifold 40 such that the valve element 50 fully closes the second outlet port 48 in the second position “P2” and closes the passage of the exhaust manifold in the first position “P1”.

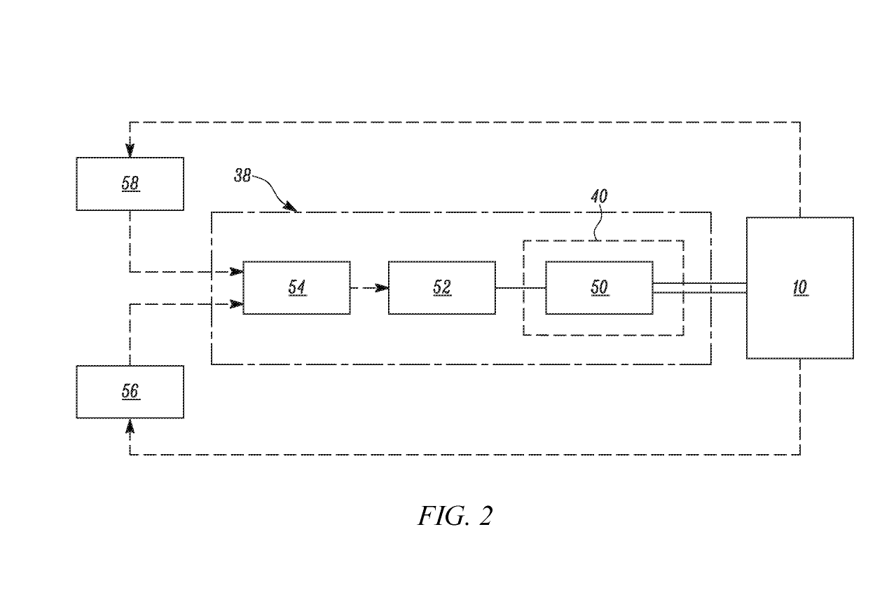

FIG. 2 is a block diagram of the system 38. The system 38 includes an actuating unit 52. The actuating unit 52 moves the valve element 50 between the first position “P1” and the second position “P2” based on operating condition of the engine 10. In an example, the actuating unit 52 may be a pneumatic actuator attached to the exhaust manifold 40. The actuating unit 52 may include a barrel (not shown) and a plunger (not shown) slidably received within the barrel. The plunger of the actuating unit 52 may be connected to the valve element 50 such that a reciprocation movement of the barrel causes the valve element 50 to move between the first position “P1” and the second position “P2”. For example, one or more linkage arms may be connected between the plunger and the valve element 50 such that a linear reciprocating movement of the plunger causes a pivotal movement of the valve element 50. Although the actuating unit 52 is described with reference to the pneumatic actuator, it is understood that the actuating unit 52 may be a hydraulic actuator, an electric actuator, a screw type actuator, or any other type of actuator known in the art.

The system 38 further includes a control module 54 in electronic communication with the actuating unit 52. Numerous commercially available microprocessors may be configured to perform the functions of the control module 54. It should be appreciated that the control module 54 may embody a machine microprocessor, for example electronic control module, capable of controlling numerous machine functions. A person of ordinary skill in the art will appreciate that the control module 54 may additionally include other components and may also perform other functions not described herein. In an example, the control module 54 may be an Engine Control Unit (ECU) of the engine 10. In another example, the control module 54 may be a separate processor in electronic communication with the ECU of the engine 10.

Further, the control module 54 is in electronic communication with an engine speed sensor 56 for determining a speed of the engine 10, and a fuel sensor 58 for determining a volume of fuel supplied to the cylinders 12. The engine speed sensor 56 may be associated with a camshaft or other components of the engine 10 from which the speed of the engine 10 may be determined. Further, the fuel sensor 58 may be associated with the intake manifold 18 and/or the fuel injectors of the engine 10.

During operation of the engine 10, the control module 54 receives inputs indicative of one or more operating parameters of the engine 10. In one example, the operating parameter may be the volume of fuel supplied to the cylinders 12. In another example, the operating parameter may be the speed of the engine 10. The volume of the fuel supplied to the cylinders 12 and the speed of the engine 10 may be detected by the fuel sensor 58 and the engine speed sensor 56, respectively. In various examples, the operating parameters may include one or more of oil temperature, oil pressure, and intake manifold air pressure. The operating parameters may be detected by using a number of additional sensors that are in communication with the control module 54 of the engine 10.

Based on the operating parameter, the control module 54 determines a value of load condition of the engine 10. In particular, based on the operating parameters of the engine 10, a load at which the engine 10 requires to be operated may be calculated. In an example, increase in volume of the fuel supplied to the engine 10 may indicate that there is demand in the load of the engine 10. The control module 54 further compares the value of the load condition of the engine 10 with a threshold in order to determine whether the engine 10 is operating at a high load condition or a low load condition. In an example, the threshold may correspond to a pre-determined range of engine load defined between a first load and a second load. The first load may be 25% of a maximum load that the engine 10 can withstand and the second load may be 10% of the maximum load. In the illustrated embodiment, the high load condition of the engine 10 may be defined as a load, at which the engine 10 is operating is equal to or greater than the first load and the low load condition of the engine 10 may be defined as a load, at which the engine 10 is operating is equal to or less than the second load.

Further, the control module 54 is configured to actuate the valve element 50 from the first position “P1” to the second position “P2” through the actuating unit 52, when the value of the load condition is less than the threshold, particularly, when the value of load condition of the engine 10 is less than the second load. Subsequently, when the value of the load condition becomes greater than the threshold, particularly, when the load condition of the engine 10 is greater than the first load, the control module 54 actuates the valve element 50 from the second position “P2” to the first position “P1” through the actuating unit 52. If the load of the engine 10 is within the first load and the second load, the valve element 50 will remain in the first position “P1”.

FIG. 3 illustrates a schematic representation of a portion of the exhaust manifold 40 having the valve element 50 disposed at the first position “P1”, FIG. 3, a central portion 60 of the exhaust manifold 40 is shown. The central portion 60 of the exhaust manifold 40 includes the first outlet port 46 and the second outlet port 48. The exhaust manifold 40 may also include a first portion (not shown) connected to a first end 62 of the central portion 60 and a second portion (not shown) connected to a second end 64 of the central portion 60. In an example, the first portion and the second portion may be fastened to or press fitted with the central portion 60. The first portion is fluidly connected to the cylinders 12A and 12B and the second portion is fluidly connected to the cylinders 12E and 12F for receiving the exhaust gas, via the inlet ports 42. In particular, the exhaust gas generated within the cylinders 12A and 12B, and 12E and 12F travels through the first portion and the second portion, respectively, to enter the central portion 60. Further, the central portion 60 also receives the exhaust gas from the cylinders 12C and 12D. The exhaust gas received from the first portion, the second portion, and the central portion 60 is allowed to enter into the turbocharger 24 through the first outlet port 46 and the second outlet port 48.

Normally the valve element 50 is disposed in the first position “P1”. Further, the valve element 50 is disposed in the first position “P1” during the high load condition of the engine 10. When the engine 10 is operating at the high load condition, the valve element 50 divides the exhaust manifold 40 such that the central portion 60 receives a first flow of exhaust gas, indicated by arrows ‘A’, from the first set of cylinders 14 (FIG. 1) and a second flow of exhaust gas, indicated by arrows ‘B’, from the second set of cylinders 16. Referring to FIG. 3, the first set of cylinders 14 is fluidly communicated with the inlet ports 42 of the first portion and one of the pair of the inlet ports 42 of the central portion 60. Similarly, the second set of cylinders 16 is fluidly communicated with the inlet ports 42 of the second portion and one of the pair of the inlet ports 42 of the central portion 60. The valve element 50 further directs the first flow of the exhaust gas received from the first set of cylinders 14 to the first outlet port 46 and the second flow of the exhaust gas received from the second set of the cylinders 16 to the second outlet port 48. Thus, at the high load condition of the engine 10, the valve element 50 splits the flow of the exhaust gas flowing into the turbocharger 24, and hence regulates a speed of the turbine 30 during the high load condition of the engine 10.

FIG. 4 illustrates a schematic representation of the central portion 60 of the exhaust manifold 40 having the valve element 50 disposed at the second position “P2”. When the engine 10 is operating at the low load condition, the control module 54 of the system 38 actuates the valve element 50 from the first position “P1” to the second position “P2” through the actuating unit 52. In the second position “P2”, the valve element 50 closes the second outlet port 48 so as to prevent any fluid communication between the exhaust manifold 40 and the turbocharger 24 through the second outlet port 48. Further, the valve element 50 allows all the exhaust gas received from the cylinders 12 to enter into the turbocharger 24 through the first outlet port 46. In the illustrated example, the valve element 50 closes the second outlet port 48 of the exhaust manifold 40 in the second position “P2”. In particular, the valve element 50 allows a third flow of exhaust gas, indicated by arrows ‘C’, received from all the cylinders 12 to enter into the turbocharger 24 through the first outlet port 46. In another example, the valve element 50 may be adapted to close the first outlet port 46 and allow the exhaust gas to enter into the turbocharger 24 through the second outlet port 48.

Although the turbocharger 24 is described with reference to single compressor 28, it is contemplated that more than one compressor may be included and disposed in parallel or series relationship in the turbocharger 24. Further, more than one turbine may also be included and disposed in parallel or series relationship in the turbocharger 24.

### INDUSTRIAL APPLICABILITY

Embodiments of the present disclosure have applicability for implementation and use in the engine 10, such as a heavy duty diesel engine, in which an efficient operation of the turbocharger 24 of the engine 10 is desired throughout a range of load conditions of the engine 10.

As described earlier, the control module 54 of the system 38 communicates with various sensors, such as the fuel sensor 58 and the engine speed sensor 56. Based on inputs received from the sensors, the control module 54 determines the value of load condition of the engine 10. The control module 54 compares the determined value of the load condition of the engine 10 with the threshold in order to determine whether the engine 10 is operating at the high load condition or at the low load condition. The control module 54 further actuates the valve element 50 between the first position “P1” and the second position “P2”, based on the determined operating condition of the engine 10. During the high load conditions, a high pressure of the pressurized air is required for efficient operation of the engine 10 as compared to the low load condition. As shown in FIG. 3, the valve element 50 of the system 38 is disposed in the first position “P1” during the high load condition of the engine 10. In the first position “P1”, the valve element 50 directs the exhaust gas received from the first set of the cylinders 14 to the first outlet port 46 and the exhaust gas received from the second set of the cylinders 16 to the second outlet port 48. Thus, the turbine 30 of the turbocharger 24 is driven by both the first flow of exhaust gas and the second flow of exhaust gas during the high load condition.

During the low load conditions, a low pressure of the pressurized air is required for efficient operation of the engine 10 as compared to the high load condition. Though a low pressure of the pressurized air is required, however, a pressure of the exhaust gas entering the turbocharger 24 may be low to drive the turbocharger 24. The control module 54 actuates the valve element 50 from the first position “P1” to the second position “P2” by the actuating unit 52, when the value of the load condition is less than the threshold i.e. during the low load conditions. In the second position “P2”, the valve element 50 allows all the exhaust gas received from the cylinders 12 to enter the first outlet port 46 thereby causing an increase in the pressure of the exhaust gas entering into the turbocharger 24. The supply of high pressure exhaust gas into the turbocharger 24 reduces the turbo lag at the low load conditions. Therefore, an efficient operation of the turbocharger 24 is obtained throughout the range of load conditions of the engine 10, thereby also facilitating in obtaining the desired power output of the engine 10.

With the use and implementation of the system 38, the turbocharger 24 provides an adequate boost pressure when the engine 10 operates in the high load condition and in the low load conditions. Further, a response time of the turbocharger 24 with respect to varying load conditions of the engine 10 is reduced. Therefore, the system 38 facilitates in reducing a fuel consumption of the engine 10 whilst maintaining the desired power output of the engine 10. Further, as the control module 54 of the system 38 may be associated with various other operations of the engine 10, an overall cost of the engine 10 is reduced.

What is claimed is:

1. A system for controlling flow of exhaust gas into a turbocharger of an engine, the system comprising:
an exhaust manifold having a plurality of inlet ports in fluid communication with a plurality of cylinders of the engine to receive the exhaust gas therefrom, and a pair of outlet ports in fluid communication with the turbocharger of the engine, wherein the pair of outlet ports includes a first outlet port and a second outlet port to communicate with a. first inlet port and a second inlet port, respectively, of the turbocharger;
a valve element pivotally coupled within the exhaust manifold between the first outlet port and the second outlet port, the valve element being movable between a first position and a second position;
an actuating unit coupled to the valve element and adapted to move the valve element between the first position and the second position; and
a control module in electronic communication with the actuating unit, the control module being configured to:
receive an input indicative of an operating parameter of the engine;
determine a value of load condition of the engine based on the operating parameter;
compare the value of the load condition of the engine with a threshold; and
actuate the valve element from the first position to the second position through the actuating unit, when the value of the load condition is less than the threshold,
wherein, in the first position, the valve element directs the exhaust gas received from a first set of the plurality of cylinders to the first outlet port and the exhaust gas received from a. second set of the plurality of cylinders to the second outlet port, and, in the second position, the valve element allows the exhaust gas received from the plurality of cylinders to enter one of the first outlet port and the second outlet port.
